(19) United States
(12) Patent Application Publication
(10) Pub. No.: US 2010/0182336 A1
(43) Pub. Date: Jul. 22, 2010

(54) LIQUID CRYSTAL DISPLAY DEVICE

(75) Inventors: Shuichi HAGA, Kanagawa (JP); Hiroaki ETO, Kanagawa (JP); Takehiro NAKATSUE, Kanagawa (JP); Yoshihide SHIMPUKU, Kanagawa (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(73) Assignee: SONY CORPORATION, Tokyo (JP)

(21) Appl. No.: 12/688,603

(22) Filed: Jan. 15, 2010

(30) Foreign Application Priority Data
Jan. 22, 2009 (JP) 2009-011927

(51) Int. Cl. G09G 5/02

(52) U.S. Cl. 345/593

(57) ABSTRACT

A liquid crystal display device includes: an acquisition unit that acquires viewing direction information indicating a direction in which a user views a displayed image; a compensation unit that adaptively compensates a chromaticity point in a video signal using the viewing direction information acquired by the acquisition unit together with color shift amount information that uses a color difference to associate the viewing direction with a color shift amount of display light; and a liquid crystal display unit that performs video display based on the video signal compensated by the compensation unit.

The present application contains subject matter related to that disclosed in Japanese Priority Patent Application JP 2009-011927 filed in the Japan Patent Office on Jan. 22, 2009, the entire content of which is hereby incorporated by reference.

### BACKGROUND OF THE INVENTION

1. Field of the Invention

The present invention relates to a liquid crystal display device that performs video display with improved viewing angle characteristics.

2. Description of the Related Art

A liquid crystal display device performs video display by modulating light from the back light using shutter operation of a liquid crystal. Accordingly, as the user changes the angle (viewing angle) from the front to an oblique direction, the luminance, contrast, color gamut, etc. of a liquid crystal display vary. This is because light leaks from the liquid crystal display panel in an oblique direction.

This problem is addressed by the IPS (in-plane switching) mode, which is a liquid crystal display mode, or the VA (vertical alignment) mode. In addition, this problem is also addressed optically by viewing an angle compensation film typified by a retardation film (see, for example, Japanese Patent No. 3724335).

### SUMMARY OF THE INVENTION

In the above retardation film, the light transmittance is compensated based on the difference in double diffraction due to the orientation of liquid crystal polymer. However, it is difficult to support all angles, so light may be unlikely to transmit at a certain angle (former case) or only the light component with a certain wavelength may transmit (latter case).

In the former, the entire luminance is reduced. In the latter, the color balance is lost, thereby causing a color shift. As described above, compensation by the liquid crystal display mode or an optical film (such as the retardation film) has a limit, so further improvement of viewing angle characteristics has been desired.

It is desirable to provide a liquid crystal display device with improved viewing angle characteristics.

According to an embodiment of the present invention, there is provided a liquid crystal display device including an acquisition unit that acquires viewing direction information indicating a direction in which the user views a displayed image, a compensation unit that adaptively compensates a chromaticity point in a video signal using the viewing direction information acquired by the acquisition unit together with color shift amount information that uses a color difference to associate the viewing direction with the color shift amount of display light, and a liquid crystal display unit that performs video display based on the video signal compensated by the compensation unit. The viewing direction indicates the direction (angle) relative to, for example, the front direction (normal direction) of the liquid crystal display unit, in which the user views the displayed image.

The liquid crystal display device according to the embodiment of the present invention acquires viewing direction information indicating the viewing direction and adaptively compensates the chromaticity point of the video signal using the viewing direction information and the color shift amount information. Then, video display is performed on the basis of the compensated video signal. This adaptively suppresses a color shift caused in response to the viewing direction (viewing angle) through the color shift amount information prepared in advance. Accordingly, a color shift caused in response to the viewing direction can be suppressed effectively as compared with a method of the related art in which an optical film such as a viewing angle compensation film is used.

In the liquid crystal display device according to the embodiment of the present invention, a chromaticity point in a video signal is adaptively compensated through viewing direction information indicating the viewing direction and the color shift amount information, and video display is performed on the basis of the compensated video signal, so a color shift caused in response to the viewing direction can be suppressed effectively as compared with a method in which an optical film is used. Accordingly, the viewing angle characteristics can be improved than ever before.

### BRIEF DESCRIPTION OF THE DRAWINGS

FIG. 1 is a perspective view showing an example of application of a liquid crystal display device according to an embodiment of the present invention.

FIG. 2 is a block diagram showing an example of the structure of the liquid crystal display device according to the embodiment of the present invention.

FIGS. 3A and 3B are characteristic diagrams showing examples of the viewing angle characteristics of display devices having various driving modes.

FIGS. 4A to 4C are characteristic diagrams showing examples of the relationship between the viewing angle and the color shift amount of the liquid crystal display device for various image quality modes.

FIGS. 5A to 5F are characteristic diagrams showing examples of the relationship between the wavelength and the spectrum intensity and the relationship between the chromaticity point and the viewing angle for various image quality modes of the liquid crystal display device during white display.

FIG. 6 is a characteristic diagram showing, for each color, an example of the relationship between the wavelength and the spectrum intensity ratio depending on the viewing angle of the liquid crystal display device in the cinema mode.

FIG. 7 is a diagram schematically showing chromaticity point compensation according to the embodiment of the present invention in response to the viewing angle.

FIG. 8 is a diagram schematically showing an example of computation in the chromaticity point compensation in FIG. 7.

FIG. 9 is a diagram showing an example of the chromaticity point compensation using the computation in FIG. 8.

FIG. 10 is a diagram showing another example of the chromaticity point compensation using the computation in FIG. 8.

FIG. 11 is a diagram illustrating a viewing angle information acquisition method according to a modification of the embodiment of the present invention.

FIG. 12 is a diagram illustrating a viewing angle information acquisition method according to another modification of the embodiment of the present invention.

### DESCRIPTION OF THE PREFERRED EMBODIMENT

An embodiment of the present invention will now be

described below with reference to the drawings in the following order.

1. Embodiment (example of a liquid crystal display device carrying out chromaticity point compensation in response to the viewing angle)

### 2. Modifications

### 1. Embodiment

### Example of the Entire Structure of a Liquid Crystal Display Device

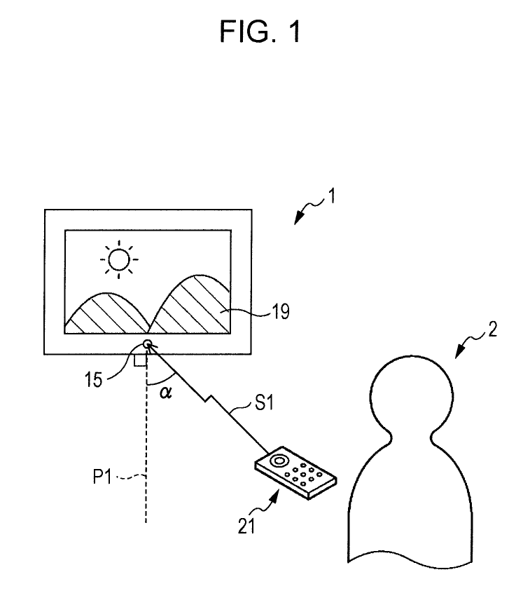

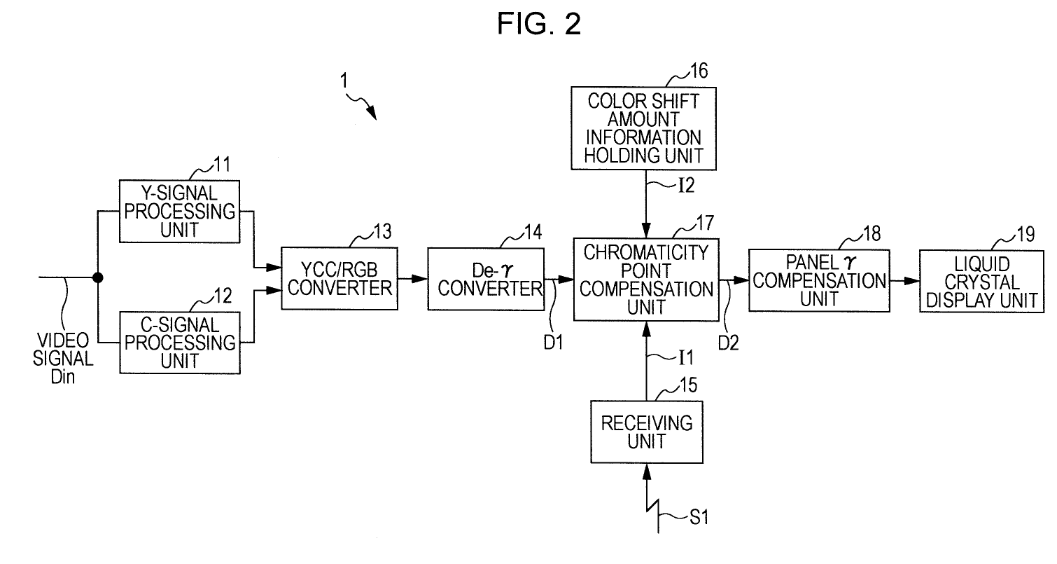

FIG. 1 shows an example of application of a liquid crystal display device (liquid crystal display device 1) according to an embodiment of the present invention. FIG. 2 shows the structure of function blocks of the liquid crystal display device 1. As shown in FIG. 1, the liquid crystal display device 1 performs color compensation (chromaticity point compensation) described later, in response to a viewing angle α, formed by a normal direction P and a viewing direction of a user 2 in FIG. 1, which is viewing direction information indicating the viewing direction. Liquid crystal display devices of this type are, for example, a liquid crystal television set, a liquid crystal display monitor for PCs, and a liquid crystal display for mobile apparatuses.

The liquid crystal display device 1 has a Y-signal processing unit 11, a C-signal processing unit 12, a YCC/RGB converter 13, a De-γ converter 14, a receiving unit 15, a color shift amount information holding unit 16, a chromaticity point compensation unit 17, a panel γ compensation unit 18, and a liquid crystal display unit 19 as shown in FIG. 2.

The Y-signal processing unit 11 performs luminance (Y) signal processing on a video signal Din in the YCC format. An example of signal processing of this type includes contrast improvement processing and edge improvement processing.

The C-signal processing unit 12 performs chroma (C) signal processing on the video signal Din in the YCC format. An example of signal processing of this type includes up-sampling by interpolation of color signals and tint control processing.

The YCC/RGB converter 13 converts a video signal (in the YCC format) that was subject to signal processing by the Y-signal processing unit 11 and the C-signal processing unit 12 into a video signal in the RGB format.

The De-γ converter 14 performs de-gamma conversion on the video signal in the RGB format supplied by the YCC/RGB converter 13. The de-gamma (De-γ) conversion will be described below. The displayed color of the same video signal may look different depending on the display device (CRT (cathode ray tube) or liquid crystal display). Gamma compensation (γ compensation) appropriate for the display device is performed to reduce the difference in color to a minimum. Accordingly, when a video signal that was compensated for CRTs is displayed on a liquid crystal display, it is necessary to invert the gamma compensation for CRTs and then perform gamma compensation for liquid crystal displays. This type of inversion is called de-gamma compensation (de-gamma conversion). The video signal that was subject to such de-gamma conversion is output to the chromaticity point compensation unit 17.

The receiving unit 15 acquires viewing angle information I1 corresponding to the viewing angle α of the user 2 as shown in FIG. 1 and outputs it to the chromaticity point compensation unit 17. In this case, the receiving unit 15 acquires the viewing angle information I1 by receiving (detecting) a control signal S1 transmitted from a certain TV remote controller 21 or other devices in response to an operation by the user 2. That is, the viewing angle α is detected on the basis of the direction in which an infrared ray is transmitted when, for example, the power switch of the television set is turned on or the volume level or channel is changed. Another method of acquiring the viewing angle information I1 with the remote controller 21 is to incorporate a gyro sensor or other angle sensor into the remote controller 21.

The color shift amount information holding unit 16 stores, in a certain memory etc., color shift amount information 12 that uses the color difference to associate the viewing angle α with the corresponding color shift amount of display light. The color shift amount information 12 is prepared in advance according to the viewing angle characteristics of a liquid crystal display panel 2 described later, and a color shift amount is set for each of a plurality of color light components constituting display light. The color shift amount information I1 will be described later in detail.

The chromaticity point compensation unit 17 adaptively compensates the chromaticity point of the video signal D1 supplied from De-γ converter 14 using the viewing angle information I1 acquired by the receiving unit 15 and the color shift amount information 12 held in the color shift amount information holding unit 16. The video signal that was subject to such chromaticity point compensation is output to the γ compensation unit 18 as the video signal D2. The compensation by the chromaticity point compensation unit 17 will be descried later in detail.

The panel γ compensation unit 18 performs γ compensation appropriate for the γ characteristics of the liquid crystal display unit 19 on the video signal D1 supplied from the chromaticity point compensation unit 17.

The liquid crystal display unit 19 includes a liquid crystal display panel and performs video display based on the video signal D1 supplied from the panel γ compensation unit 18.

The receiving unit 15 corresponds to a specific example of an acquisition unit according to the embodiment of the present invention and the chromaticity point compensation unit 17 corresponds to a specific example of a compensation unit according to the embodiment of the present invention.

### [Example of the Viewing Angle Characteristics of the Display Device]

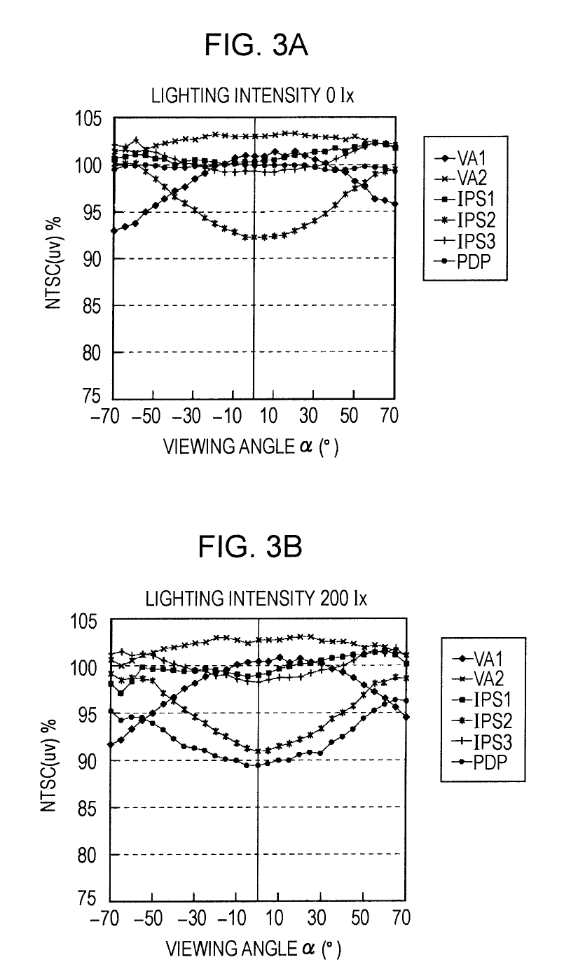

Next, the viewing angle characteristics (specifically, a color shift depending on the viewing angle) of the display device will be described with reference to FIGS. 3 to 6.

First, FIGS. 3A and 3B illustrate the viewing angle characteristics of display devices of various driving modes; FIG. 3A illustrates the viewing angle characteristics in lighting with an intensity of 0 lx and FIG. 3B illustrates the viewing angle characteristics in lighting with an intensity of 200 lx. Each of “VA1” and “VA2” in the drawings indicates a liquid crystal display device having a VA mode liquid crystal display. Each of “IPS1”, “IPS2”, and “IPS3” in the drawings indicates a liquid crystal display device having an IPS mode liquid crystal display. “PDP” indicates a PDP (plasma display panel) mode display device.

As shown in FIGS. 3A and 3B, the color shift of the gamut of PDP mode display devices and IPS mode liquid crystal display devices is less than that of VA mode liquid crystal display devices. In the lighting environment with an intensity of 200 lx, the characteristics of PDP mode display devices were degraded. This degradation may be largely due to external light generated by surface reflection.

A color difference was measured for each color light component to check in what wavelength of light (in what color light component) a change in the color gamut (color shift) occurs. As the color difference, the term (Δu′, v′) defined by expression (1) is used. Typically, ΔE is used as the color difference, but a change in the luminance component is included in ΔE. Accordingly, (Δu′, v′) is used to measure only the change in color.

[Expression 1]

Δu′,v′=√(u′front−u′observation viewing angle)²+(v′front−v′observation viewing angle)² (1)

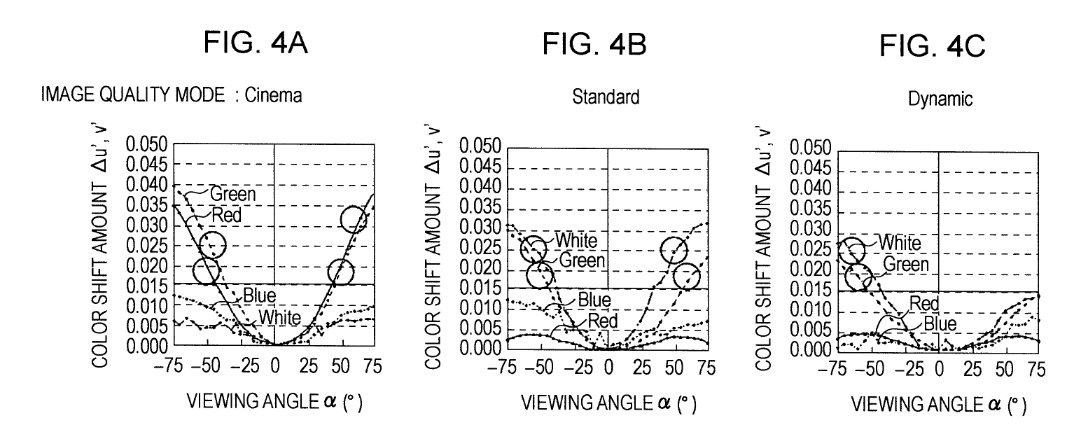

FIGS. 4A to 4C show examples of the relationship between the viewing angle α and the color shift (color difference Δu′, v′) of a VA mode liquid crystal display device for various image quality modes. FIG. 4A shows the characteristics in the cinema mode, FIG. 4B shows the characteristics in the standard mode, and FIG. 4C shows the characteristics in the dynamic mode. “Red”, “Green”, “Blue”, and “White” in the diagrams indicate the characteristics in red display, green display, blue display, and white display, respectively.

The measurement angle, which corresponds to the viewing angle α, ranges from −75 degrees to 75 degrees centered on the front direction (0 degrees). The measurement was made in a pitch dark environment (with a lighting intensity of 0 lx) to eliminate effects of the external environment. The reference value of the color shift (color difference Δu′, v′), which is also used as the reference of chromaticity point compensation described later, was set to 0.015. For a color shift amount of 0.015, which was obtained from a subjective evaluation experiment (see “Measurement of Color Viewing Angle for Display” on page 2147 in the IDW 2008 Announcement Overview), 50% or more of people feel uncomfortable with the color. The portions in the diagram that exceed this reference value are indicated by circles.

Referring to FIGS. 4A to 4C, in the cinema mode, if the absolute value of the viewing angle α is equal to or larger than a certain angle, the reference value 0.015 is exceeded in red display and green display. In the standard mode and the dynamic mode, if the absolute value of the viewing angle α is equal to or larger than a certain angle, the reference value is exceeded in while display and green display.

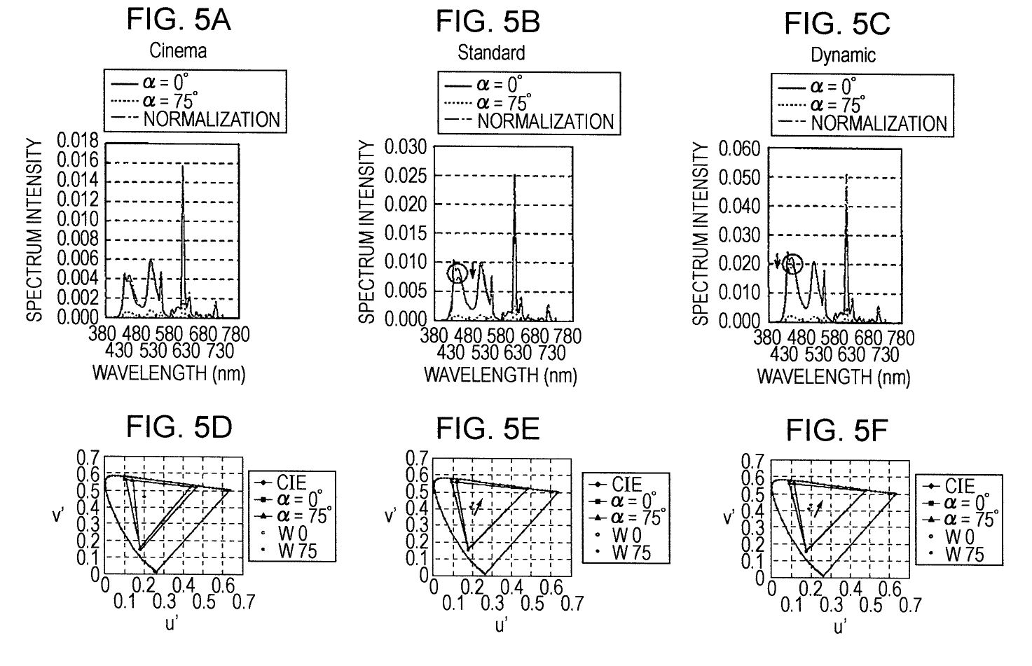

Next, spectroscopic measurement was made to identify what wavelength of light component leaks during a color shift. FIGS. 5A to 5F illustrate examples of the relationship between the wavelength and the spectrum intensity and the relationship between the chromaticity point and the viewing angle α for the individual image quality modes of the liquid crystal display device in white display. FIGS. 5A and 5D show the characteristics in the cinema mode, FIGS. 5B and 5E show the characteristics in the standard mode, and FIGS. 5C and 5F show the characteristics in the dynamic mode. FIGS. 5A to 5C show the relationship between the wavelength and the spectrum intensity of display light; the characteristics at a viewing angle α of 0 degrees (front direction), the characteristics at a viewing angle α of 75 degrees, and the spectrum intensity at a viewing angle α of 75 degrees normalized to the spectrum intensity at a viewing angle α=0 degrees are illustrated. FIGS. 5C to 5F show the color gamuts at viewing angles α of 0 degrees and 75 degrees together with the CIE (Commission Internationale d'Eclairage) gamut, in chromaticity diagrams (u′-v′ chromaticity diagrams). “W 0” in the diagrams indicates the chromaticity point of the white light component at a viewing angle α of 0 degrees and “W 75” indicates the chromaticity point of the white light component at a viewing angle α of 75 degrees.

Referring to FIGS. 5A to 5F, the blue light component is reduced in the standard mode and the dynamic mode as indicated by circles and arrows in white display. That is, it is predicted that the chromaticity point of the white light component shifts as indicated by arrows in chromaticity diagrams because the blue light component is filtered at a viewing angle α of 75 degrees and the color balance is lost.

Although not shown in the diagrams, in red display, a spectrum change was observed in the cinema mode. That is, a peak that appears in the wavelength area between the blue light component and green light component was mixed with the red light component, resulting in a shift in the chromaticity point of the red light component. This type of change did not appear in the standard mode and the dynamic mode.

Although not shown in the diagrams, in green display, a peak component of the red light component that is present in a wavelength area near 600 nm was increased in all image quality modes and this peak component was mixed with the green light component, resulting in a shift in the chromaticity point of the green light component.

Although not shown in the drawings, in blue display, the green light component increased slightly in the cinema mode, but there was no significant change as compared with the cases in other colors.

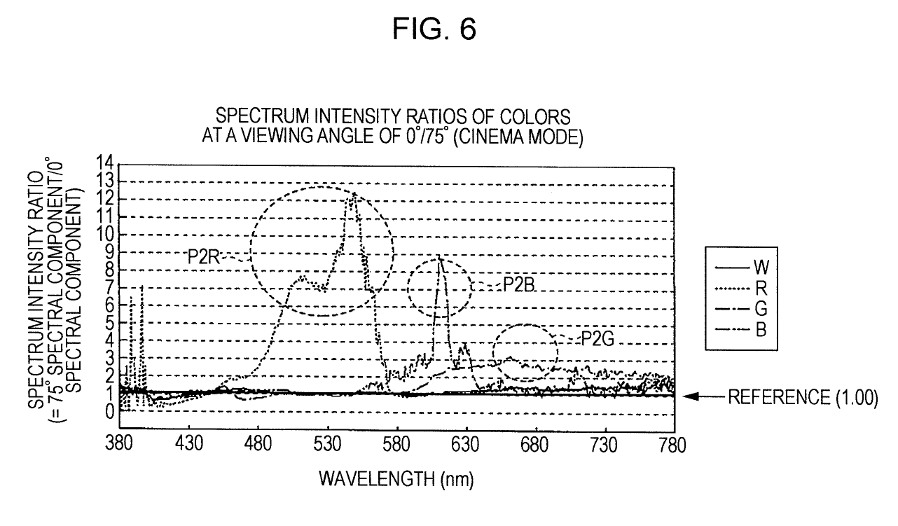

FIG. 6 is illustrates, for each color, the relationship between the wavelength and the spectrum intensity ratio (spectral component at a viewing angle α of 75 degrees/spectral component at a viewing angle α of 0 degrees) depending on the viewing angle α in the cinema mode.

As indicated by P2R, P2G, and P2B in FIG. 6, spectra of impurity components that deviate from the reference value (=1.00) are present for all colors.

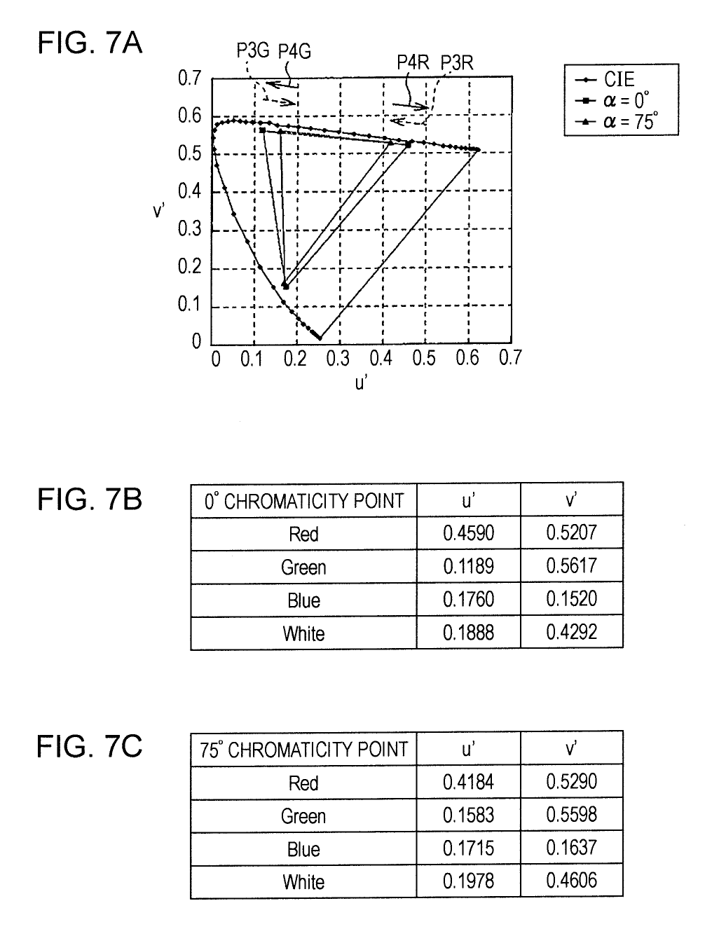

As described above, a spectrum change for each wavelength is caused by a color shift and the amount (ratio) of intensity change can be obtained quantitatively. Specifically, as shown in FIGS. 7B and 7C, the color shift can be obtained quantitatively based on differences in the chromaticity point values of color light components of display color. The differences in the chromaticity point values depending on the viewing angle cause color shifts indicated by, for example, arrows P3R and P3G in FIG. 7A.

As described above, in the present embodiment, the color shift amount information 12 described above is created and prepared in advance for each display device based on the measurement results indicating the relationship between the color shift defined by (color difference Δu′, v′) and the scattering spectrum of display light. Specifically, as described above, the color shift amount information 12 is created by identifying the trend in which the spectrum intensity increases or decreases depending on the viewing angle α and the corresponding wavelength area. The color shift amount information 12 includes the color shift defined by (color difference Δu′, v′) for each of a plurality of color light components constituting display light.

### [Example of Chromaticity Point Compensation]

In the liquid crystal display device 1 according to the present embodiment, the chromaticity point compensation unit 17 compensates the increasing/decreasing of a scattering spectrum at regular angle intervals using the color shift amount information 12. This can reverse changed chromaticity points and improve color shifts, as indicated by arrows P4R and P4G in FIG. 7A.

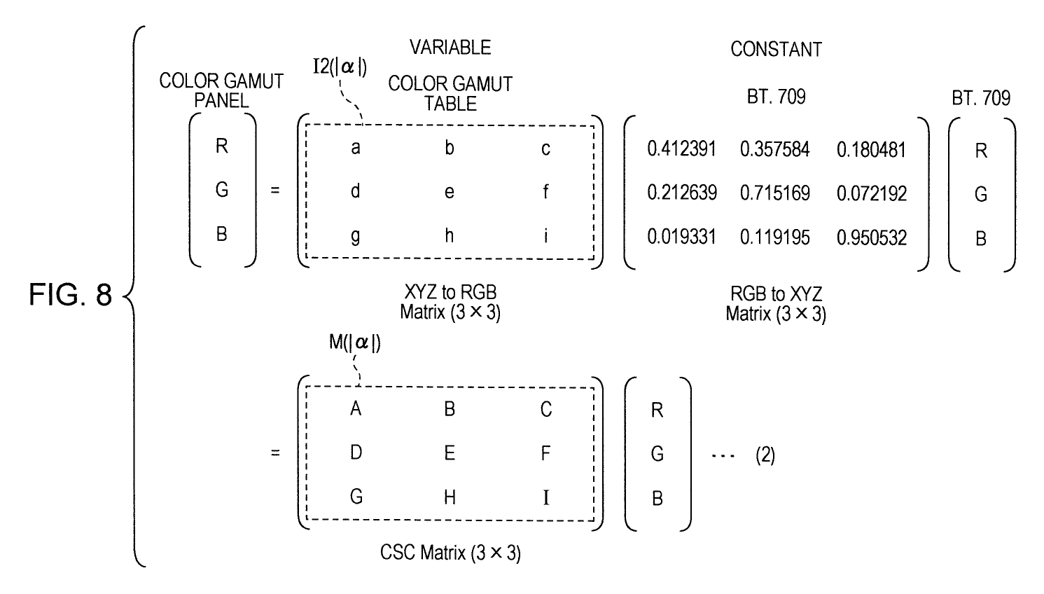

Specifically, the chromaticity point compensation unit 17 compensates the video signal D1 using the color shift amount information 12 including coefficients for CSC (color space conversion) of the input video signal D4, as shown in, for example, expression (2) in FIG. 8. That is, coefficients for CSC (color space conversion) used for matrix operation for converting color difference signals into RGB signals are adjusted so that the increasing/decreasing of a scattering spectrum can be canceled.

The CSC is generally performed to make adjustment according to the γ characteristic or panel chromaticity point. Recently, television sets with a liquid crystal display panel having a color gamut wider than the HD (high definition) broadcasting gamut (BT709) is commercially available. A wide color gamut CCFL (cold cathode fluorescent lamp) or an LED (light emitting diode) is used as the light source of backlight to widen the color gamut. Accordingly, to display the current signal wave on a wide color gamut television set, it is necessary to adjust the chromaticity point of the panel to that of BT709. This adjustment is performed by CSC matrix calculation above. In the present embodiment, coefficients for CSC are used to perform compensation even for a color shift, which is a change in the chromaticity point depending on the viewing angle α. In coefficients for CSC, α value is preferably set at regular angle intervals (for example, at angle intervals of 5 degrees) in response to the increasing/decreasing in the spectrum.

Specifically, in expression (2), a matrix M(|α|) for calculating RGB signals at the absolute value |α| of an arbitrary viewing angle α is defined by multiplication of a color gamut table I2(|α|) (variable corresponding to the color shift amount information I2), which depends on the absolute value |α|, and the color gamut stable (constant) of the underlying BT709. As the variable term, the maximum

color gamut of the liquid crystal panel is used for the front direction (|α|=0 degrees), so the maximum chromaticity point of the liquid crystal panel is used. As the value for each angle (value for |α|>0 degrees), the variable term obtained from the chromaticity point based on the viewing angle α is used. The value for each angle is measured in advance, calculated as the tristimulus values of X, Y, and Z, and converted into RGB signals with a 3×3 matrix.

### [Example of Operation of the Liquid Crystal Display Device 1]

Next, the operation of the liquid crystal display device 1 according to the present embodiment will be described below.

In the liquid crystal display device 1, the Y-signal processing unit 11 and the C-signal processing unit 12 receive the video signal Din and perform Y-signal processing and C-signal processing and the YCC/RGB converter 13 converts the video signal in the YCC format into that in the RGB format. Next, the De-γ converter 14 performs predetermined conversion on the converted video signal and inputs the video signal to the chromaticity point compensation unit 17 as the video signal D1. The chromaticity point compensation unit 17 performs chromaticity point compensation described below and inputs the compensated video signal D2 to the panel γ compensation unit 18. The panel γ compensation unit 18 compensates the video signal D2 and the liquid crystal display unit 19 performs video display based on the compensated video signal.

At this time, when the receiving unit 15 receives the control signal S1 transmitted from the remote controller 21 in response to an operation by the user 2, the receiving unit 15 acquires information (viewing angle information I1) about the viewing angle α of the user 2.

Next, the chromaticity point compensation unit 17 adaptively compensates the chromaticity point of the vide signal D1 based on this viewing angle information I1 and the color shift amount information 12 held in the color shift amount information holding unit 16 and the chromaticity point compensation unit 17 generates the video signal D2.

Specifically, the chromaticity point compensation unit 17 compensates the video signal D1 with expression (2) in FIG. 8.

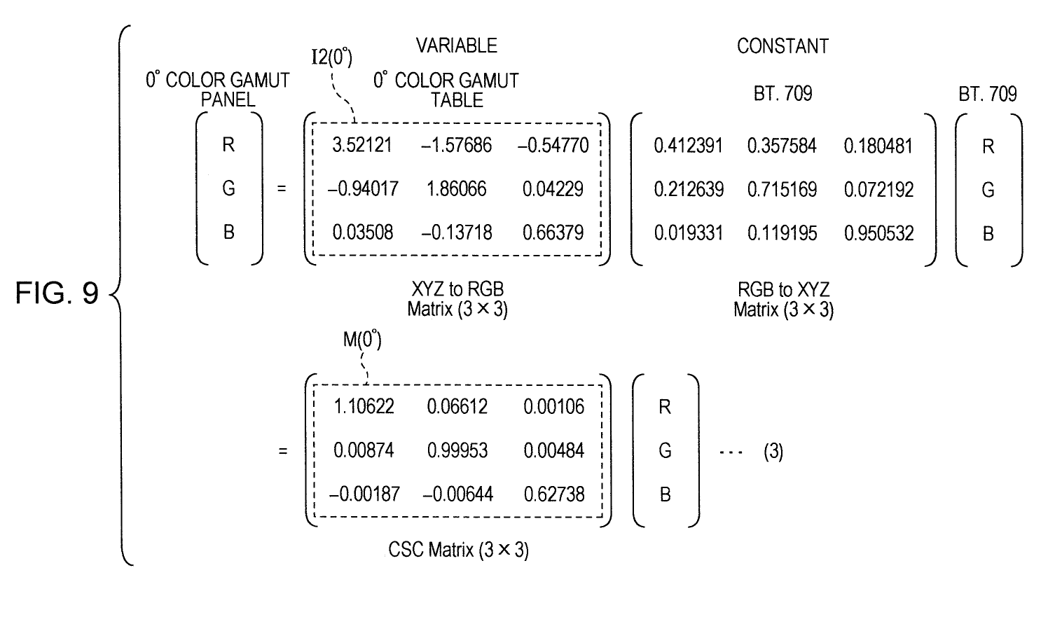

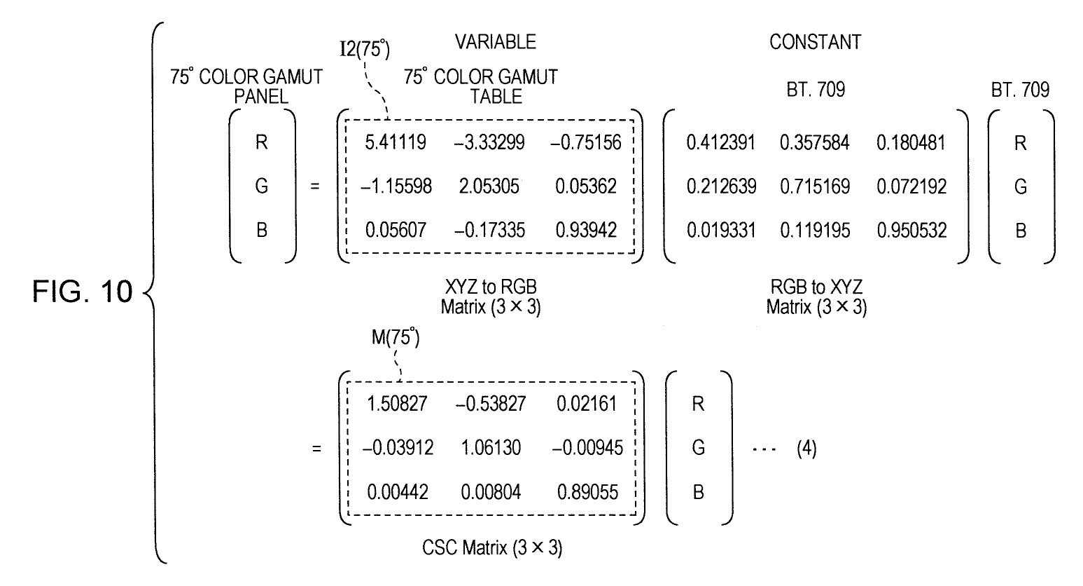

That is, when |α| equals 0 degrees, matrix calculation is performed with coefficients for CSC shown in, for example, expression (3) in FIG. 9. When |α| equals 75 degrees, matrix calculation is performed with coefficients for CSC as shown in, for example, expression (4) in FIG. 10.

As described above, in the present embodiment, the chromaticity point of the video signal D1 is adaptively compensated through the viewing angle information I1 and the color shift amount information 12 and video display is performed based on the compensated video signal D2. This adaptively suppresses a color shift that occurs depending on the viewing angle, as compared with compensation of the related art in which an optical film such as a viewing angle compensation film is used.

As described above, in the present embodiment, the chromaticity point compensation unit 17 adaptively compensates the chromaticity point of the video signal D1 based on the viewing angle information I1 corresponding to the viewing angle α and the color shift amount information 12 and performs video display based on the compensated video signal D2 so as to effectively prevent a color shift from occurring depending on the viewing angle. Accordingly, the viewing angle characteristics can be improved than ever before.

The user 2 can view a displayed image with less color shift regardless of the location.

In addition, the liquid crystal display device according to the present embodiment can address the problem that is not compensated by viewing angle improvement effects of an optical film. The cost is lower than compensation with an optical film because it is sufficient to change coefficients of computation.

In addition, the color shift amount information 12 is acquired on the basis of the control signal S1 transmitted from the remote controller 21 in response to an operation by the user 2, so the existing remote controller 21 can be used, making the operation easier.

### 2. Modification

An embodiment of the present invention has been described above, but this is not a limitation; various modifications are possible.

For example, in the above embodiment, when the user 2 is located at a certain viewing angle, a color shift is adjusted automatically using the setting corresponding to the viewing angle. However, it is also possible to make compensation only when the color shift at a certain viewing angle exceeds a predetermined threshold. That is, it is possible to make compensation only when the color shift amount exceeds a predetermined upper limit (for example, 0.015 shown above).

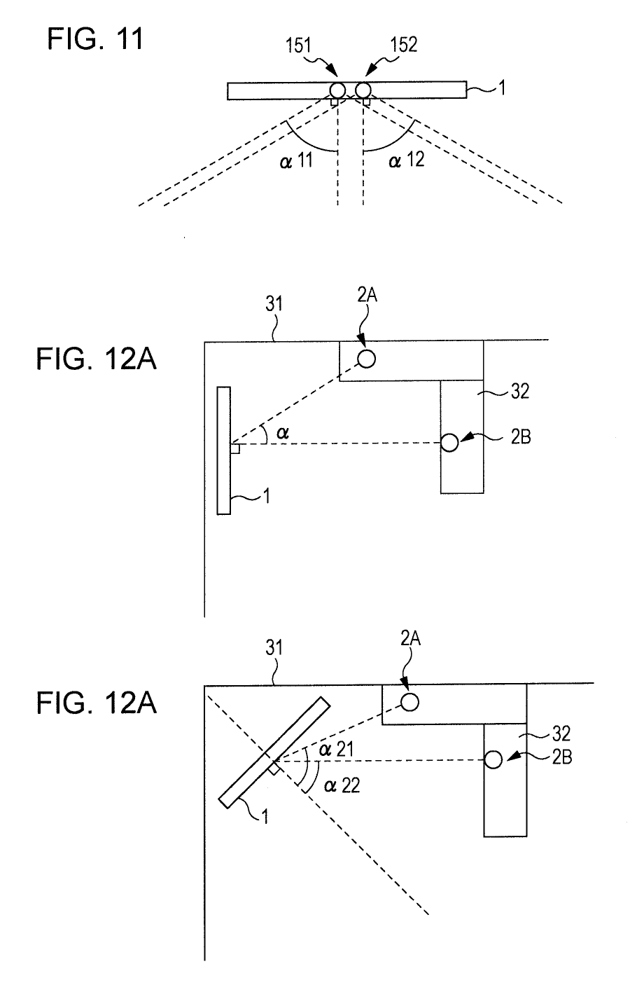

In the above embodiment, the viewing angle information I1 is acquired by receiving the control signal S1 transmitted from the remote controller 21 in response to an operation by the user 2, but the acquisition of the viewing angle information I1 is not limited to this method. Specifically, as shown in, for example, FIG. 11, the viewing angle information I1 may be acquired by a camera 151, an IR (infrared) sensor 152, an RF (radio frequency) sensor (not shown), or the like that is incorporated in the liquid crystal display device 1. In addition, these functions may be combined.

Typically, the liquid crystal display device 1 such as a television set or the like is placed in a corner or near a wall 31 of a room as shown in, for example, in FIGS. 12A and 12B; the user sits on a sofa 32 to view a displayed image. Accordingly, as shown in the drawings, the viewing angle significantly depends on the position of the liquid crystal display device 1 or the position on the sofa 32 (see user 2A and 2B and viewing angles α, α21, and α22 in the drawings). When any number of users (for example, the two users 2A and 2B) are present, the viewing angle information I1 may be acquired with the camera 151, the IR sensor 152, or the like incorporated in the liquid crystal display device 1 as described above.

In the above embodiment, a so-called direct view liquid crystal display device has been described, but the present invention is applicable to a front projection or rear projection liquid crystal display device (liquid crystal projector).

The present application contains subject matter related to that disclosed in Japanese Priority Patent Application JP 2009-011927 filed in the Japan Patent Office on Jan. 22, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid crystal display device comprising:
an acquisition unit that acquires viewing direction information indicating a direction in which a user views a displayed image;
a compensation unit that adaptively compensates a chromaticity point in a video signal using the viewing direction information acquired by the acquisition unit together with color shift amount information that uses a color difference to associate the viewing direction with a color shift amount of display light; and
a liquid crystal display unit that performs video display based on the video signal compensated by the compensation unit.

2. The liquid crystal display device of claim 1, wherein the compensation unit compensates the chromaticity point when the color shift amount is equal to or more than a predetermined threshold in the viewing direction corresponding to the viewing direction information

3. The liquid crystal display device of claim 1, wherein the color shift amount information includes the color shift amount set for each of a plurality of color light components constituting the display light.

4. The liquid crystal display device of claim 1, wherein the color shift amount information includes coefficients for color space conversion of the video signal.

5. The liquid crystal display device of claim 1, wherein the color shift amount information is created by identifying a trend in which a spectrum intensity increases or decreases depending on the viewing angle and a corresponding wavelength area, based on a measurement result indicating a relationship between the color shift amount and a scattering spectrum of the display light.

6. The liquid crystal display device of any one of claims 1 to 5, wherein the acquisition unit acquires the viewing direction information by detecting a signal transmitted from a predetermined remote controller in response to a user operation.
